(19) United States
(12) Patent Application Publication
(10) Pub. No.: US 2024/0416236 A1
(43) Pub. Date: Dec. 19, 2024

(54) GENERATIVE SYSTEM, GENERATIVE SYSTEM CONTROL PROGRAM, AND CONTROL METHOD

(71) Applicant: KONAMI DIGITAL ENTERTAINMENT CO., LTD., Tokyo (JP)

(72) Inventor: Tetsuro ISHIDA, Tokyo (JP)

(73) Assignee: KONAMI DIGITAL ENTERTAINMENT CO., LTD., Tokyo (JP)

(21) Appl. No.: 18/817,469

(22) Filed: Aug. 28, 2024

Related U.S. Application Data
(63) Continuation of application No. PCT/JP2022/047904, filed on Dec. 26, 2022.

(30) Foreign Application Priority Data
Mar. 31, 2022 (JP) 2022-059476

(51) Int. Cl. A63F 13/53; A63F 13/46

(52) U.S. Cl. CPC A63F 13/53; A63F 13/46

(57) ABSTRACT

A generative system that generates a distribution screen of a viewing video of a battle type game in which win or lose is determined by changing a battle situation according to use of a game object by each opponent and includes a computer, wherein the computer: acquires superiority/inferiority information indicating superiority or inferiority of the battle situation and specific information specifying a factor object that is a factor of the battle situation among the game objects; and generates the distribution screen such that a superiority/inferiority display area indicating the superiority or inferiority of the battle situation for at least one opponent based on the superiority/inferiority information and an object display area indicating the factor object based on the specific information are located on a same screen.

### BACKGROUND OF THE INVENTION

### Field of the Invention

The present invention relates to a generative system that generates a distribution screen provided with a superiority/inferiority display area, a generative system control program, and a control method.

### Description of the Related Art

Patent Literature 1 discloses a game system including a game processing unit having a momentum parameter update condition determination unit and a display control unit. Then, the momentum parameter update condition determination unit determines whether an update condition of the momentum parameter is satisfied. In addition, the display control unit performs display control of a momentum display object visually representing a magnitude relationship of momentum parameter values of each team.

Patent Literature 2 discloses a viewer terminal for viewing a motion video output from a motion video distribution device. The display of the viewer terminal is provided with an area for displaying a hitting probability and a degree of risk for each of tiles in hands of one player of a plurality of players in the game.

### CITATION LIST

### Patent Literature

Patent Literature 1: JP2005-204948A

Patent Literature 2: JP6797986B

### SUMMARY OF THE INVENTION

In a viewing video of a battle type game, information (for example, information indicating which opponent is advantageous) indicating superiority or inferiority of a battle situation may be displayed. This makes it easy for a viewer to understand a state, but the viewer may not be able to understand a reason why the battle situation has become superior or inferior. For example, considerable explanation is required to allow the viewer to understand what has affected the state. Therefore, a prepared live announcer or commentator verbally explains factors that have affected the state. However, it is not always possible to prepare the live announcer or commentator, and it is desirable to present information that allows the viewer to understand what has affected the state.

A generative system according to one aspect is a generative system that generates a distribution screen of a viewing video of a battle type game in which win or lose is determined by changing a battle situation according to use of a game object by each opponent and includes a computer, wherein the computer: acquires superiority/inferiority information indicating superiority or inferiority of the battle situation and specific information specifying a factor object that is a factor of the battle situation among the game objects; and generates the distribution screen such that a superiority/inferiority display area indicating the superiority or inferiority of the battle situation for at least one opponent based on the superiority/inferiority information and an object display area indicating the factor object based on the specific information are located on a same screen.

In addition, a control program according to another aspect is a control program of a generative system that generates a distribution screen of a viewing video of a battle type game in which win or lose is determined by changing a battle situation according to use of a game object by each opponent and includes a computer, the control program causing the computer to: acquire superiority/inferiority information indicating superiority or inferiority of the battle situation and specific information specifying a factor object that is a factor of the battle situation among the game objects; and generate the distribution screen such that a superiority/inferiority display area indicating the superiority or inferiority of the battle situation for at least one opponent based on the superiority/inferiority information and an object display area indicating the factor object based on the specific information are located on a same screen.

In addition, a control method according to another aspect is a control method of a generative system that generates a distribution screen of a viewing video of a battle type game in which win or lose is determined by changing a battle situation according to use of a game object by each opponent and includes a computer, the control method comprising: acquiring by the computer, superiority/inferiority information indicating superiority or inferiority of the battle situation and specific information specifying a factor object that is a factor of the battle situation among the game objects; and generating by the computer, the distribution screen such that a superiority/inferiority display area indicating the superiority or inferiority of the battle situation for at least one opponent based on the superiority/inferiority information and an object display area indicating the factor object based on the specific information are located on a same screen.

### Advantageous Effects of Invention

As a result, it is possible to distribute information that allows a viewer to understand an object that has affected a state.

### BRIEF DESCRIPTION OF THE DRAWINGS

FIG. 1 is a schematic overall diagram of a generative system according to a first embodiment.

FIG. 2 is a schematic diagram illustrating an example of a distribution screen according to the first embodiment.

FIG. 3 is a schematic block diagram of the generative system according to the first embodiment.

FIG. 4 is a flowchart of processing according to the first embodiment.

FIG. 5 is a schematic overall diagram of a generative system according to a second embodiment.

FIG. 6 is a schematic diagram illustrating an example of a distribution screen according to the second embodiment.

FIG. 7 is a schematic block diagram of the generative system according to the second embodiment.

FIG. 8 is a flowchart of processing according to the second embodiment.

### DESCRIPTION OF THE EMBODIMENTS

Hereinafter, exemplary embodiments for carrying out the present invention will be described in detail with reference to the drawings. However, the dimensions, materials, shapes and relative positions of the components described in the following embodiments can be arbitrary set and can be changed according to the configuration of an apparatus or a method to which the present invention is applied or to various conditions. Unless otherwise specified, the scope of the present invention is not limited to the embodiments specifically described below.

### First Embodiment

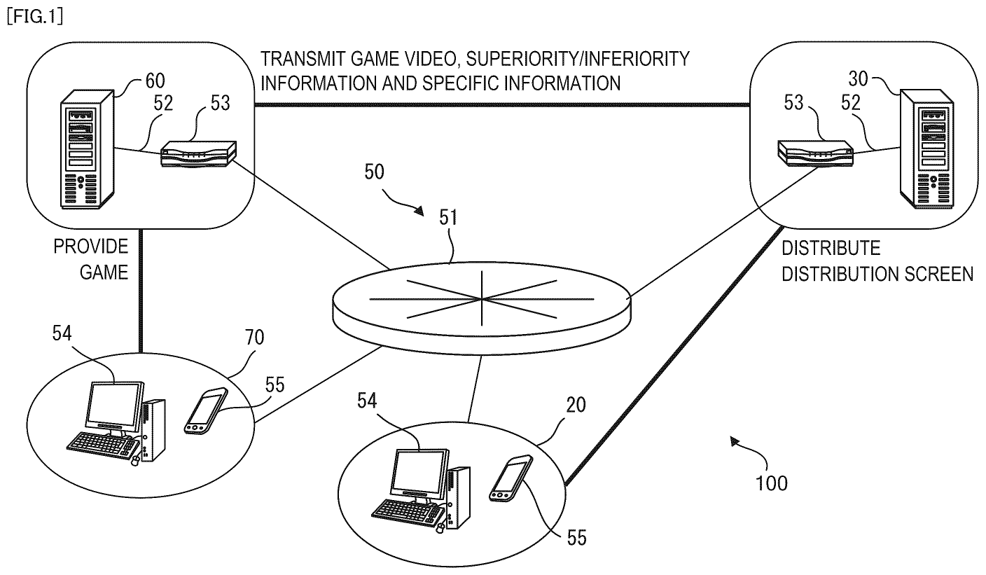

As illustrated in FIG. 1, a generative system 100 that generates a distribution screen of a viewing video also functions as a game system, and includes a game server 60 that transmits a game video which is an example of the viewing video, and a game terminal 70 which is an example of a game device for playing a game. For example, the viewing video is a video of a game screen displayed on the game terminal 70 and is included in the distribution screen. The game terminal 70 can be coupled to the game server 60 via a predetermined network 50. As an example, a player of the game uses the game terminal 70 in a predetermined facility such as a home, a site of a game tournament, or a store.

In addition, the generative system 100 can also function as a distribution system, and further includes a reproduction terminal 20 which is an example of a user terminal, and a distribution server 30 that distributes a distribution screen including a game video. The reproduction terminal 20 can be coupled to the distribution server 30 via the predetermined network 50. As an example, the viewer uses the reproduction terminal 20 at home.

The distribution server 30 and the game server 60 are configured as one logical server device by combining server units as a plurality of computers. However, the distribution server 30 and the game server 60 may be configured by a single server unit. Alternatively, the distribution server 30 and the game server 60 may be logically configured using cloud computing. Incidentally, the distribution server 30 and the game server 60 can be provided in one server. For example, the game server 60 can also function as the distribution server 30. Furthermore, the game server 60 can also function as the distribution server 30.

The distribution server 30 provides the reproduction terminal 20 or a user who owns the reproduction terminal 20 with a distribution service for viewing a distribution screen. For example, the distribution server 30 distributes a distribution screen including a game video acquired from the game server 60 to the reproduction terminal 20. Alternatively, the distribution server 30 may distribute a distribution screen including a game video received from a device other than the game server 60. As an example, the distribution server 30 may distribute a distribution screen including a game video created by a player of a game or another distributor. In this case, the distribution server 30 distributes a distribution screen including a game video uploaded by the player or other distributor to the reproduction terminal 20.

In addition, the distribution service includes a service that distributes and updates a program or data for the reproduction terminal 20 via the network 50. The distribution server 30 appropriately distributes various programs or data necessary for viewing the distribution screen to each reproduction terminal 20 through the distribution service. In addition, the game video includes a video of a game screen of a game played by the game terminal 70, a camera video created by photographing a game screen or the like, and a video related to the game such as a camera video obtained by photographing a player of the game, a spectator watching the game, or the like.

For example, the distribution server 30 provides a Web service to the user of the reproduction terminal 20 via the network 50. In the Web service, when the distribution server 30 provides the distribution service, a distribution screen reproduced on the reproduction terminal 20 is distributed. Incidentally, the Web service may include other services such as an information providing service that provides various types of information regarding the game video, a community service that provides a place for interaction such as transmission, exchange, and sharing of information by users, and a service that provides user identification information for identifying each user.

The game server 60 provides various services for the game device to the game terminal 70 or the user of the game terminal 70. The service includes a distribution service that distributes and updates a program or data for the game terminal 70 via the network 50. The game server 60 appropriately distributes various programs or data necessary for providing the game service to each game terminal 70 through the distribution service.

The game server 60 provides a battle type game in which win or loss is determined by changing a battle situation according to use of a game object by each opponent. Here, the battle situation is a situation indicating to which opponent the possibility of winning or losing of the game is inclined. The provided game may be a battle type game using a game object, and examples thereof include a trading card game, a music game, a board game, a mahjong game, an RPG game, a fighting game, a puzzle game, a quiz game, a simulation game, and a sports game such as baseball and soccer. For example, the game server 60 may provide a service for a baseball game, as the sports game, including a training part for training a baseball player and a battle part for causing a team to which the trained baseball player belongs to fight against an opponent team. Incidentally, the use of the game object includes disposing an object at a predetermined position (for example, a predetermined square), exerting an effect (for example, a summation) of the object, making an attack or defense by the object, configuring a predetermined object group (for example, a predetermined hand) including the object, and the like.

In addition, the game object is a virtual or physical object displayed on the screen or used by the user in the game. As an example, the object is used in game processing for progressing the game, and includes a card, a character, a magic, a trap, a monster, an effect, equipment, an item, and the like. Incidentally, in the following description, an example of a trading card game using a group of objects called a deck or a team will be mainly described. However, in the game, the group of objects may be referred to as a group of articles or organisms, a military force, a corps, a group, or the like.

### [Outline of Game]

A player fights against a player of an opponent using a plurality of cards selected from a deck created by the player as hands. In a battle, a turn of the player and a turn of the opponent player are alternately repeated. Then, in the turn of the player, the player attacks the opponent with the card selected from the hands, and decreases a life point (also simply referred to as LP) of the opponent player. As a result, when the life point of the opponent player disappears, the player wins against the opponent player. In addition, the card includes a monster card, a magic card, and a trap card. In each card, a card name, a card type, an attribute, a level, a kind, a description, an effect, a usage, an attack power, a defense power, and the like are set.

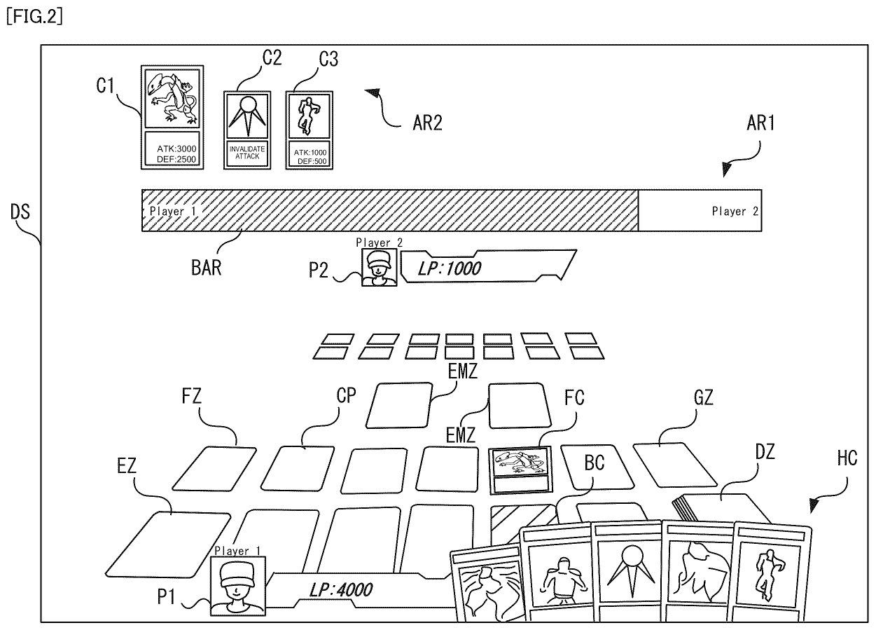

FIG. 2 illustrates an example of a distribution screen DS including a game video. The game is advanced using a game field as an example of a place where the cards are to be disposed by a player P1 and a player P2. A plurality of card placement places CP are set in the game field. As an example, ten card placement places CP are set for each player. In addition, in the game field, a cemetery zone GZ in which broken or used cards are placed and a field zone FZ in which field magic cards that affect the entire field are placed are set.

In addition, in the game field, an extra deck zone EZ in which cards that can be summoned in a special method are placed and a deck zone DZ in which a deck is placed are set. Further, an extra monster zone EMZ is set so as to overlap a boundary between a game field of the player P1 and a game field of the player P2. The player P1 and the player P2 can select either one of the two extra monster zones EMZ and place a card summoned by a special method.

Each player forms a deck to be used in the game from a large number of cards owned by the player, and advances the game while appropriately disposing the cards included in the deck in the card placement place CP or each zone. In the game, each player holds some cards as hands HC or places some cards at an appropriate position outside the game field. For example, in FIG. 2, the player P1 holds five cards as the hands HC. In addition, the player P1 places a front-side display card FC and a back-side display card BC in the card placement place CP. The front-side display card FC is a monster card and corresponds to a card image C1. In addition, the back-side display card BC is a trap card and corresponds to a card image C2. For example, the back-side display card BC exerts a chained effect in association with the front-side display card FC so as to exhibit an effect of invalidating the attack on the front-side display card FC.

The game progresses in a so-called turn-based system in which turns are alternately repeated between players. First, as preparation for the game, for example, the deck of each player is shuffled and then disposed in the deck zone DZ, and a predetermined number of cards are drawn from the deck of the player and held as the hands HC. When the preparation is completed, the game is started from a turn of a player who attacks first. One turn is divided into a plurality of phases. The phase is a concept for dividing a procedure to be performed in one turn into a plurality of stages according to contents and properties thereof.

Each player selects an appropriate action within a range determined for each phase. As an example, in a phase 1, a card is drawn from the deck, and in a phase 2, an effect of the card to be subjected to effect processing in the phase can be activated. In a phase 3, various actions such as calling (or summon) of a virtual character or the like such as a monster used in a battle, setting of a card having a unique effect such as a magic or a trap, or activation of an effect of a card are permitted while appropriately using the card. In a phase 4, a battle using the card is performed. For example, a battle is performed by selecting a card to be used for an attack and a card to be an attack target. Instead of or in addition to the card, the opponent player may be the attack target.

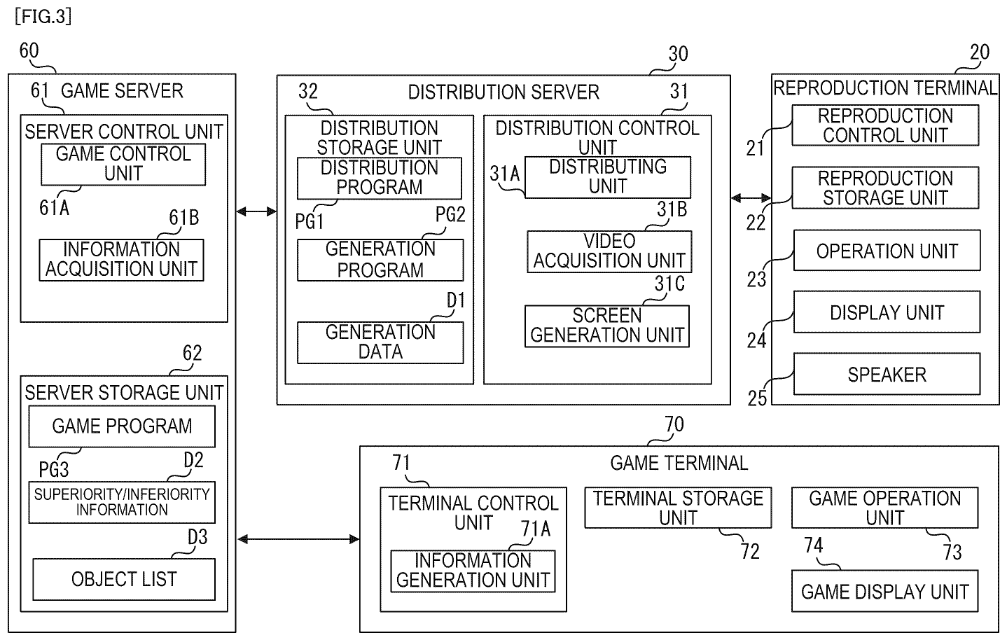

The result of the battle is determined according to parameters such as the attribute and strength of the card. In a phase 5, the end of the turn is declared. Incidentally, each player can avoid the battle of the phase 4 by his/her own selection. In the case, the phase 4 is skipped. Selection processing of cards to be used or disposed and end or start processing of each phase are performed by an operation on a game operation unit 73 (FIG. 3) of the game terminal 70. Alternatively, each processing may be performed by a method such as voice input or automatic processing by the game terminal 70. Then, when a predetermined end condition is satisfied while the turns are alternately repeated, the game ends. The end condition is satisfied, for example, when a value of a parameter such as a life point set to each player decreases to a predetermined value (for example, zero) due to the battle.

Returning to FIG. 1, the service for the game device provided by the game server 60 may include a service in which the game server 60 receives player identification information of a player from the game terminal 70 and authenticates the player. In addition, the service for the game device may include a service in which the game server 60 receives and stores the video of the game screen or play data including the play result of the authenticated player from the game terminal 70. Furthermore, the service for the game device may include a service for providing the play data stored by the game server 60 to the game terminal 70. In addition, the service for the game device may include a service in which the game server 60 matches players when a plurality of players play a common game via the network 50. In addition, the service for the game device may include a service in which the game server 60 collects a fee from a player.

The network 50 is configured to be able to couple each of the reproduction terminal 20 and the game terminal 70 to the distribution server 30 and the game server 60. As an example, the network 50 is configured to realize network communication by using a TCP/IP protocol. Specifically, a LAN 52 couples each of the distribution server 30 and the game server 60 to the Internet 51. Then, the Internet 51 as a WAN and the LAN 52 are coupled via a router 53.

The reproduction terminal 20 and the game terminal 70 are also configured to be coupled to the Internet 51. In addition, the distribution server 30 and the game server 60, and the reproduction terminal 20 and the game terminal 70 may be coupled to each other via the Internet 51 instead of or in addition to the LAN 52. Incidentally, in FIG. 1, a thin line indicates coupling to the Internet 51, and a thick line indicates a service to be provided, information to be transmitted, and the like. The thick line does not indicate that the devices directly communicate with each other, but the devices may be configured to directly communicate with each other.

The reproduction terminal 20 and the game terminal 70 are computer devices capable of network coupling. For example, the reproduction terminal 20 and the game terminal 70 include a stationary or book type personal computer 54 and a mobile terminal device 55 such as a mobile phone (including a smartphone). In addition, various computer devices such as a stationary home game device, a portable game device, and a portable tablet terminal device are included in the reproduction terminal 20 and the game terminal 70. The reproduction terminal 20 and the game terminal 70 can allow the user to enjoy various services provided by the distribution server 30 and the game server 60 by mounting various computer software. Specifically, the reproduction terminal 20 functions as a display terminal of a distribution screen DS including a game video through video reproducing software. In addition, the game terminal 70 functions as a game device through software for the game device. Incidentally, the reproduction terminal 20 and the game terminal 70 may be an arcade game machine.

As an example, in the generative system 100, the game server 60 provides a game service to the game terminal 70. Then, the game server 60 records a game video of the game played by the game terminal 70 or a game video created by photographing a game screen or the like. The game video may be a video related to the game, such as a video obtained by photographing a player of the game or a spectator watching the game. Moreover, the game server 60 may regenerate the game video by rendering key information received from the game terminal 70. Then, the game server 60 transmits the acquired or created game video to the distribution server 30. Then, the distribution server 30 distributes a distribution screen DS including the received game video to the reproduction terminal 20.

### [Control System of Generative System 100]

Next, a control system of the generative system 100 will be described with reference to FIG. 3. First, the distribution server 30 includes a distribution control unit 31, a distribution storage unit 32, and a communication unit (not illustrated). The distribution control unit 31 executes various controls for distributing the distribution screen DS including the game video received from the game server 60. In addition, the distribution storage unit 32 stores a distribution program PG1 which is a control program of the distribution server 30. The distribution by the distribution server 30 only needs to be in a form of distributing to the respective reproduction terminals 20 simultaneously, and may be in a form of livestreaming which is video distribution in real time, or may be, for example, in a form of distributing an edited video, not in real time. In addition, it is not limited to the form of simultaneous distribution, and may be a form of on-demand distribution in which distribution is individually performed by an operation of each user.

In addition, the distribution storage unit 32 stores a generation program PG2 that functions as a control program of the generative system 100 in cooperation with a game program PG3 and generation data D1 used for generating the distribution screen DS. The generation data D1 includes image data of images displayed in a superiority/inferiority display area AR1 (FIG. 2) and an object display area AR2 (FIG. 2), data of a screen configuration, and the like. As an example, in the superiority/inferiority display area AR1, a superiority/inferiority display bar BAR that increases in area when the state is superior is displayed. In addition, in the object display area AR2, card images C1, C2, and C3 (for example, a front side image of a card and an image of a piece or a tile) indicating factor objects, and an image of a character string indicating a name, an ID, or the like are displayed.

The game server 60 includes a server control unit 61, a server storage unit 62, and a communication unit (not illustrated). The server control unit 61 executes various controls for providing a game service to the game terminal 70. Further, the server control unit 61 uploads the game video to the distribution server 30. In addition, the server storage unit 62 stores the game program PG3 for providing a game service to the game terminal 70.

Furthermore, the server storage unit 62 stores game data (not illustrated). As an example, the game data includes data necessary for providing various games such as image data, BGM data, and play data of a player. The play data is data for inheriting the content unique to each player such as a play history (for example, past record) of the player from a next time.

The distribution control unit 31 and the server control unit 61 are configured as a computer in which a processor that executes various types of arithmetic processing and operation control according to a predetermined program, an internal memory necessary for the operation of the processor, and other peripheral devices are combined. As an example, these processors are a central processing unit (CPU) or a micro-processing unit (MPU), and control the entire device based on a predetermined program and also integrally control various types of processing.

The distribution storage unit 32 and the server storage unit 62 are storage devices including a computer-readable non-transitory storage medium. The distribution storage unit 32 and the server storage unit 62 include a random access memory (RAM) which is a system work memory for the processor to operate, and a storage device such as a read only memory (ROM), a hard disc drive (HDD), and a solid state drive (SSD) for storing a program and system software. The processor can execute processing operations such as various calculations, controls, and determinations according to a program stored in the ROM or the HDD. The distribution program PG1, the generation program PG2, and the game program PG3 may function as a control program of the generative system 100 in cooperation. Incidentally, the distribution storage unit 32 and the server storage unit 62 may hold all the data in one storage device, or may store the data in a plurality of storage devices in a distributed manner.

A display device that displays an input state, a setting state, a measurement result, and various types of information of the device is coupled to the distribution control unit 31 and the server control unit 61 in a wired or wireless manner. In addition, an operation device including a keyboard or various switches for inputting predetermined commands and data is coupled to the distribution control unit 31 and the server control unit 61 in a wired or wireless manner. Incidentally, the distribution control unit 31 and the server control unit 61 can also perform control according to a program stored in a portable recording medium such as a compact disc (CD), a digital versatile disc (DVD), a compact flash (CF) card, or a universal serial bus (USB) memory, or an external storage medium such as a server on the Internet.

The reproduction terminal 20 includes a reproduction control unit 21, a reproduction storage unit 22, an operation unit 23 as an operation device, a display unit 24 as a display device, a speaker 25 as a voice output device, and a communication unit (not illustrated). The reproduction storage unit 22 stores a control program of the reproduction terminal 20 and a reproduction program of the distribution screen DS which is an example of an application program. The reproduction control unit 21 controls the reproduction terminal 20 and executes the reproduction program to display the distribution screen DS on the display unit 24.

In addition, the operation unit 23 is an operation device such as a controller or a touch panel, and receives an input of a user operation by the user. In addition, the display unit 24 is a display device such as a television, a display, or a touch panel, and displays the distribution screen DS viewed by the user. The operation unit 23 and the display unit 24 may be integrally configured as a display operation unit such as a touch panel. As the game video is reproduced, the speaker 25 outputs related voice such as game voice. Incidentally, the operation unit 23, the display unit 24, and the speaker 25 may be integrated with or separated from the reproduction terminal 20.

The game terminal 70 includes a terminal control unit 71, a terminal storage unit 72, a game operation unit 73, a game display unit 74, and a communication unit (not illustrated). The terminal storage unit 72 stores a control program of the game terminal 70. The terminal control unit 71 controls the game terminal 70 and executes the control program to allow a player to play a game. The game operation unit 73 is an operation device such as a controller or a touch panel, and receives an input of a game operation by a player. The game operation unit 73 and the game display unit 74 may be integrally configured as a display operation unit such as a touch panel. Furthermore, the game terminal 70 may include a camera that photographs a player or the like. In this case, the game terminal 70 transmits the camera video photographed by the camera to the game server 60 together with the game screen. Alternatively, the camera may be provided separately from the game terminal 70. In this case, the camera may transmit the camera video to the distribution server 30 instead of the game server 60.

The game display unit 74 is a display device such as a display or a touch panel, and displays a game screen of a game played by a player. The game operation unit 73 and the game display unit 74 may be integrated with or separated from the game terminal 70. Furthermore, the game terminal 70 includes a voice output device (not illustrated). Incidentally, the terminal control unit 71 controls the progress of the game by executing the control program, but may control the progress of the game in cooperation with the server control unit 61. For example, the server control unit 61 may control the progress of at least a part of the game, and the terminal control unit 71 may display the result on the game display unit 74. In addition, the server control unit 61 collects play data from the game terminal 70 and manages the collected play data. Further, the server control unit 61 of the game server 60 collects key information and the like for reconstructing the game video from the game terminal 70.

The reproduction control unit 21 and the terminal control unit 71 are configured as a computer in which a processor that executes various types of arithmetic processing and operation control according to a predetermined program, an internal memory necessary for the operation of the processor, and other peripheral devices are combined. As an example, these processors are CPUs or MPUs, and control the entire device based on a predetermined program, and also control various types of processing in an integrated manner. Incidentally, the reproduction control unit 21 and the terminal control unit 71 can also perform control according to a program stored in a portable recording medium such as a CD, a DVD, a CF card, or a USB memory, or an external storage medium such as a server on the Internet.

The reproduction storage unit 22 and the terminal storage unit 72 are storage devices including a computer-readable non-transitory storage medium. Then, the reproduction storage unit 22 and the terminal storage unit 72 include a RAM that is a system work memory for the processor to operate, and a storage device such as a ROM, an HDD, and an SSD that store a program and system software. The processor can execute various processing operations such as calculation, control, and determination according to a control program stored in the ROM or the HDD. Incidentally, the reproduction storage unit 22 and the terminal storage unit 72 may hold all data in one storage device, or may store data in a plurality of storage devices in a distributed manner.

### [Game Server 60]

The server control unit 61 includes a game control unit 61A which is an example of a game control device that manages the progress of the game. In addition, the server control unit 61 includes an information acquisition unit 61B which is an example of an information acquisition device. Then, the game control unit 61A and the information acquisition unit 61B are logical devices realized by a combination of hardware resources and software resources of the server control unit 61.

When each player activates an application program of the game in the game terminal 70, the game terminal 70 accesses the game server 60. Then, the game control unit 61A performs predetermined user authentication and performs matching with another player. When the matching is completed, the game control unit 61A starts the game from a turn of a player who attacks first. Then, the game control unit 61A progresses the game according to a predetermined procedure. Thereafter, the game control unit 61A ends the game when a predetermined end condition is satisfied. Alternatively, the terminal control unit 71 of the game terminal 70 may progress the game by a peer-to-peer method.

The information acquisition unit 61B acquires superiority/inferiority information and specific information. The superiority/inferiority information indicates superiority or inferiority of a battle situation, and is a value indicating a winning probability or a losing probability of each player as an example. Alternatively, the superiority/inferiority information may be a value indicating a life point of each player. In addition, the specific information is information for specifying a factor object that is a factor of the battle situation among game objects. As an example, the specific information is object identification information for uniquely identifying each object. For example, the object identification information is a card name or a card ID of a specific object.

The terminal control unit 71 of the game terminal 70 includes an information generation unit 71A as an example of an information generation device. Then, the information generation unit 71A analyzes a battle situation, creates superiority/inferiority information and specific information, and transmits the information to the game server 60. As a result, the superiority/inferiority information and the specific information can be automatically created, and superiority/inferiority and a factor object can be indicated to the viewer. Then, the information acquisition unit 61B stores received superiority/inferiority information D2 in the server storage unit 62 in association with player identification information for uniquely identifying each player and information indicating a time zone (for example, an elapsed time from the start of the game, a number of turns, or a number of phases). Further, the information acquisition unit 61B stores an object list D3 based on the received specific information in the server storage unit 62 in association with the information indicating the time zone. That is, the game server 60 includes the server storage unit 62 as an example of a storage device that stores the superiority/inferiority information and the specific information. Incidentally, the information acquisition unit 61B may acquire the superiority/inferiority information and the specific information from the terminal storage unit 72 as an example of a storage device. Incidentally, the specific information in each time zone may indicate only one card or a plurality of cards. Further, the superiority/inferiority information may be a value or may be an image such as a superiority/inferiority display bar BAR or a superiority/inferiority display graph.

For example, the information generation unit 71A analyzes a battle situation at a timing when the turn or phase changes. Then, the information generation unit 71A creates the superiority/inferiority information and the specific information, and passes the information to the game server 60 in association with the information indicating the time zone in the game. As an example, the information generation unit 71A analyzes the battle situation using a predetermined algorithm stored in advance in the terminal storage unit 72. In addition, the information generation unit 71A analyzes the battle situation based on an object (for example, a card) used or usable by each player. For example, the information generation unit 71A evaluates a degree to which each card placed in the game field contributes to winning. Then, the information generation unit 71A evaluates superiority/inferiority of each card between the players and predicts a battle situation. Incidentally, the information generation unit 71A may combine the turns of a plurality of opponents into one set, and analyze the battle situation at a timing when the one set of turns changes. For example, the information generation unit 71A may analyze the battle situation at a timing when a set of turns including a turn of one player and a turn of the other player is changed, or at a timing when a set of turns including a turn of the other player and a turn of the one player is changed. In addition, the information generation unit 71A may analyze the battle situation with reference to past battle information or the like (for example, past winning rate or the like) of the player. However, since the past battle information is not taken into consideration, the possibility that the contribution degree of the object and the prediction of the battle situation match is increased.

In addition, the information generation unit 71A may analyze the battle situation based on expectation values of parameters such as attack capability and defense capability of objects used or usable by each player. For example, the information generation unit 71A may compare an expectation value using a probability of attack by the player P1 at a certain turn and damage due to the attack, and an expectation value using a probability of attack by the player P2 at a next turn and damage due to the attack to analyze the battle situation. Furthermore, the information generation unit 71A may analyze the battle situation based on an expectation value for achieving a condition. When the expectation value is used, the expectation value of each player may be regarded as the superiority/inferiority information. For example, when an expectation value of the player P1 of a certain turn is 3000 and an expectation value of the player P2 of the next turn is 1000, a length of the superiority/inferiority display bar BAR of the player P1 is three times that of the player P2.

As another example, the information generation unit 71A may predict a factor object using a learned model stored in advance in the terminal storage unit 72 and predict a winning rate of each player from the cards included in the hands and the cards placed in the game field. Incidentally, the information generation unit 71A may be provided in the server control unit 61 of the game server 60. Furthermore, when the game progresses by the peer-to-peer method, the information generation unit 71A of the game terminal 70 on the host side may create the superiority/inferiority information and the specific information.

The information acquisition unit 61B may acquire the winning rate of each player stored in the server storage unit 62 in advance by the live announcer, the commentator, or the operator of the game server 60 and the name of the card that is a factor of the winning rate. As a result, it is possible to indicate the superiority/inferiority in the superiority/inferiority display area AR1 and indicate the factor object in the object display area AR2 using the information stored in advance. In this case, the information acquisition unit 61B acquires the winning rate as the superiority/inferiority information from the server storage unit 62, and acquires the name of the card as the specific information. Alternatively, each player may input his/her winning rate and the name of the card to be a factor of the winning rate to the game terminal 70. In this case, the information acquisition unit 61B acquires the input winning rate as the superiority/inferiority information from the game terminal 70, and acquires the input name of the card as the specific information.

### [Distribution Server 30]

The distribution control unit 31 includes a distributing unit 31A as an example of a distributing device that manages distribution of the distribution screen. In addition, the distribution control unit 31 includes a video acquisition unit 31B as an example of a video acquisition device, and a screen generation unit 31C as an example of a screen generation device. Further, the distributing unit 31A, the video acquisition unit 31B, and the screen generation unit 31C are logical devices realized by a combination of hardware resources and software resources of the distribution control unit 31.

The distributing unit 31A distributes a distribution screen DS generated by the screen generation unit 31C to each reproduction terminal 20. Therefore, as illustrated in FIG. 2, the screen generation unit 31C generates the distribution screen DS such that the superiority/inferiority display area AR1 and the object display area AR2 are located on the same screen. In this way, by providing the superiority/inferiority display area AR1 and the object display area AR2, the viewer can easily recognize the reason for the superiority/inferiority indicated in the superiority/inferiority display area AR1. In addition, the viewer can recognize the factor object that has affected the superiority/inferiority indicated in the superiority/inferiority display area AR1. Therefore, a degree of understanding of the battle situation of the game is increased, and the viewer can enjoy the game video more.

The screen generation unit 31C receives the superiority/inferiority information D2 transmitted by the server control unit 61. Then, the screen generation unit 31C indicates, in the superiority/inferiority display area AR1, superiority or inferiority of the battle situation with respect to at least one opponent based on the superiority/inferiority information D2. For example, the screen generation unit 31C displays the superiority/inferiority display bar BAR indicating superiority/inferiority in the superiority/inferiority display area AR1. The superiority/inferiority display bar BAR indicates that the longer is in the superior state. In the example of FIG. 2, while a life point of the player P1 is 4000 points, a life point of the player P2 is 1000 points. Therefore, the superiority/inferiority display bar BAR indicates that a winning rate of the player P1 is 80% and a winning rate of the player P2 is 20%. That is, the screen generation unit 31C displays the superiority/inferiority display bar BAR in the superiority/inferiority display area AR1 such that the length of the player P1 is four times that of the player P2.

Incidentally, when there are two opponents, the screen generation unit 31C may display the superiority/inferiority display bar BAR for both opponents or may display the superiority/inferiority display bar BAR for only one opponent. For example, the screen generation unit 31C may not display the superiority/inferiority display bar BAR for an inferior opponent. Even in this case, the viewer can know a superior opponent and a reason for the superior state. Therefore, when at least the superior opponent can be displayed, the demand of the viewer can be satisfied. Furthermore, when there are three or more opponents, the screen generation unit 31C may display the superiority/inferiority display bar BAR for at least one opponent. Alternatively, the screen generation unit 31C may display the superiority/inferiority display bar BAR divided into three.

In addition, instead of the superiority/inferiority display bar BAR, the screen generation unit 31C may indicate the superiority/inferiority by a ratio based on 100%. Furthermore, the screen generation unit 31C may indicate the superiority/inferiority by a number or a character (for example, the character of superior or inferior). In addition, the screen generation unit 31C may indicate the superiority/inferiority by indicating a superior player in a mode different from an inferior player. For example, the screen generation unit 31C may display a name or image of the superior player in a relatively more emphasized manner than a name or image of the inferior player. The emphasized display may be a display that varies in size, transmittance, density, chromaticity, saturation, brightness, shape, hue, or a combination thereof.

In addition, the screen generation unit 31C receives an object list D3 as specific information transmitted by the server control unit 61. Then, the screen generation unit 31C indicates a factor object in the object display area AR2 based on the object list D3. In the example of FIG. 2, the screen generation unit 31C displays the card images C1, C2, and C3 to indicate the factor objects. As a result, in distributing a game video of a competitive game, the screen generation unit 31C can indicate to the viewer the superiority/inferiority and indicate to the viewer the factor objects (for example, cards) greatly contributing to the change in the battle situation. Specifically, the screen generation unit 31C indicates the superiority/inferiority display bar BAR on the distribution screen DS in a graph format so that the viewer can easily understand. In addition, the screen generation unit 31C displays the card images C1, C2, and C3 of the cards that are the ground of superiority in descending order of influence on the battle situation.

The specific information is, for example, the object list D3. For example, the object list D3 is a list of object identification information for uniquely identifying each object. In addition, the object included in the object list D3 may be selected from usable objects, for example, cards of hands HC of a player or cards of the deck, in addition to the object used by the player. In the object list D3, object identification information associated with the player identification information is listed in a state of being rearranged in the order of the contribution degree in each time zone. In addition, in the object list D3, the object identification information associated with the contribution degree may be listed. Incidentally, depending on the game, usable objects may be selected from an object group called by other names (stock cards, stock tiles, a hand piece, or the like).

In addition, the screen generation unit 31C may indicate the factor object by a name, an identification number, an abbreviation, or the like of the object. Furthermore, the screen generation unit 31C may generate the distribution screen DS such that an explanation area (not illustrated) of the factor object is located on the same screen together with the object display area AR2. For example, in addition to the card images C1, C2, and C3, the screen generation unit 31C provides the explanation area so that characters or images indicating the explanation of the reason for being selected as the factor object are further indicated. For example, the screen generation unit 31C further displays a numerical value indicating the contribution degree or an explanatory sentence indicating a reason why the contribution degree is high. As a result, the viewer can understand the reason for the superiority/inferiority indicated in the superiority/inferiority display area AR1 in more detail.

Further, the screen generation unit 31C displays one or two or more factor objects in the object display area AR2. In addition, the screen generation unit 31C may display the factor objects in the object display area AR2 in a predetermined number (for example, three) only after arranging the factor objects in descending order of the contribution degree or the like. As a result, it is possible to suppress that a large number of card images are displayed and the factor object becomes difficult to be understood.

Furthermore, the screen generation unit 31C may display a group of objects that will be used or that have been used in a predetermined order in the object display area AR2 as the factor objects. For example, the screen generation unit 31C displays the factor objects in the object display area AR2 after arranging the factor objects in the order in which the factor objects will be used or in the order in which the factor objects have been used. In the game, there is a case where a next object can be continuously used due to the effect of the previously used object. The objects used in this chained manner result in a series of changes that change the battle situation, provided that they are used in a predetermined order. At this time, when a group of objects are displayed side by side in order, the viewer can have a higher understanding of the change in the battle situation. Incidentally, the order in which the objects will be used or the order in which the objects have been used is acquired by the information acquisition unit 61B from the game terminal 70 and stored in the server storage unit 62 in association with the specific information.

Further, the screen generation unit 31C changes display contents in the superiority/inferiority display area AR1 and the object display area AR2 according to the change in the battle situation. That is, the screen generation unit 31C replaces the superiority/inferiority display bar BAR and the card images C1, C2, and C3 in the past (for example, past turns or phases) with the current ones. In this case, the screen generation unit 31C may generate the distribution screen DS so as to include a history display area (not illustrated) in which a past display content displayed before a latest display content is displayed.

That is, the screen generation unit 31C may display past superiority/inferiority and the factor object as a history indicating the past display content for the same game video. For example, the screen generation unit 31C provides the history display area side by side with the superiority/inferiority display area AR1. Then, the screen generation unit 31C displays the superiority/inferiority display bar BAR and the card images C1, C2, and C3 of the past turns corresponding to the immediately preceding two turns in the history display area. As a result, the viewer can understand the reason for the superiority/inferiority indicated in the superiority/inferiority display area AR1 in more detail. Incidentally, the screen generation unit 31C may display the superiority/inferiority and the factor object of the past turn in a smaller size.

In addition, the screen generation unit 31C may display a card having a high contribution degree in a relatively emphasized manner. For example, the screen generation unit 31C displays a card having a highest contribution degree to be the largest. As a result, the viewer can visually recognize the change in the factor object more easily. Furthermore, the screen generation unit 31C may display a performance image in the superiority/inferiority display area AR1 when the battle situation changes, for example, when the superiority/inferiority is reversed. This allows the viewer to visually recognize the change in the battle situation more quickly. In addition, the screen generation unit 31C may compare the past superiority/inferiority and factor objects with the current superiority/inferiority and factor objects and display information indicating a change in the situation in the superiority/inferiority display area AR1. For example, the screen generation unit 31C may cause the distribution screen DS to display an explanatory sentence or a performance image indicating that the situation has reversed or the superiority/inferiority difference has increased.

In addition, in the example of FIG. 2, the object display area AR2 is provided only for the superior player P1. However, the object display area AR2 may be provided for each of the player P1 who is superior and the player P2 who is inferior. However, when at least the superior opponent can be displayed, the demand of the viewer can be satisfied. Furthermore, when there are three or more opponents, the screen generation unit 31C may indicate the factor object for at least one of the opponents.

The screen generation unit 31C may position the superiority/inferiority display area AR1 and the object display area AR2 on the same screen in at least a part of a time zone from the start to the end of the game video. For example, at least one of the superiority/inferiority display area AR1 and the object display area AR2 may not be included in the distribution screen DS in a time zone before the start of the game or after the end of the game, a time zone at the early stage of the game in which the determination of the superiority/inferiority is not made, and a time zone at the final stage of the game in which it is necessary to hide the result of the game from the viewer.

In addition, the screen generation unit 31C generates the distribution screen DS so as to include the game video (and the display region of the game video), the superiority/inferiority display area AR1, and the object display area AR2. As an example, the screen generation unit 31C generates the distribution screen DS by processing the game video such that the superiority/inferiority display area AR1 and the object display area AR2 are superimposed on the game video to be displayed. For this purpose, the screen generation unit 31C acquires data of a screen configuration and the like included in the generation data D1 in the distribution storage unit 32 and generates the distribution screen DS. The distribution screen DS is generated as an image or a video. For example, the screen generation unit 31C generates the distribution screen DS in various formats such as an MPEG format. Then, the distributing unit 31A displays the distribution screen DS on a Web page to be accessed by the user.

Specifically, the screen generation unit 31C superimposes an upper layer including the superiority/inferiority display area AR1 and the object display area AR2 on a lower layer including the display region of the game video. The upper layer is configured as a transparent image so as not to disturb the display of the game video. As a result, the superiority/inferiority display area AR1 and the object display area AR2 are displayed so as to be superimposed on a part of the game video. Alternatively, the screen generation unit 31C may superimpose the upper layer on the lower layer so as not to overlap the game video.

Furthermore, in the example of FIG. 2, the superiority/inferiority display area AR1 is provided side by side with the object display area AR2. However, the superiority/inferiority display area AR1 may be provided at a position away from the object display area AR2 as long as the object display area AR2 and the superiority/inferiority display area AR1 are displayed at the same time. For example, the object display area AR2 may be provided in the vicinity of an image indicating each player or a player name. In this case, the superiority/inferiority display area AR1 may be provided in an upper part, a lower part, a right part, or a left part of the distribution screen DS.

Furthermore, the superiority/inferiority display area AR1 may be provided inside the object display area AR2. In addition, the object display area AR2 may be provided inside the superiority/inferiority display area AR1. For example, a part of the superiority/inferiority display bar BAR illustrated in FIG. 2 may be superimposed on the card images C1, C2, and C3 indicating the factor objects.

Alternatively, the screen generation unit 31C may be provided in the server control unit 61 of the game server 60. In this case, the video acquisition unit 31B of the distribution server 30 acquires the distribution screen DS including the game video together with the game video from the game server 60. Then, the distributing unit 31A distributes the acquired distribution screen DS.

Incidentally, the screen generation unit 31C changes or updates the contents to be indicated in the superiority/inferiority display area AR1 and the object display area AR2 at a predetermined timing. For example, the screen generation unit 31C changes or updates the contents at the timing when the superiority/inferiority information and the specific information are received from the information acquisition unit 61B. Alternatively, the screen generation unit 31C changes or updates the contents at the end of each turn or each phase.

The video acquisition unit 31B acquires a game video of a game. As an example, the video acquisition unit 31B acquires a game video from the game server 60. Alternatively, the video acquisition unit 31B may acquire a photographed game video from a photographing device (for example, a video camera) (not illustrated). Moreover, the video acquisition unit 31B may acquire the game video from the game terminal 70. Then, the screen generation unit 31C generates the distribution screen DS such that the game video acquired by the video acquisition unit 31B, the superiority/inferiority display area AR1, and the object display area AR2 are located on the same screen.

Incidentally, the video acquisition unit 31B acquires the game video from the game terminal 70 (for example, in the case of the peer-to-peer method, the game terminal 70 that functions as a host terminal) of one of the two opponents. Alternatively, the video acquisition unit 31B may acquire the game videos from the respective game terminals 70 of both opponents. As a result, although the hands HC of the opponent player are not normally shown in the game video, the hands HC of both opponents can be shown in the game video. As an example, the screen generation unit 31C generates the distribution screen DS such that the game videos from the respective game terminals 70 of both opponents are arranged vertically or horizontally.

### [Processing by Generative System 100]

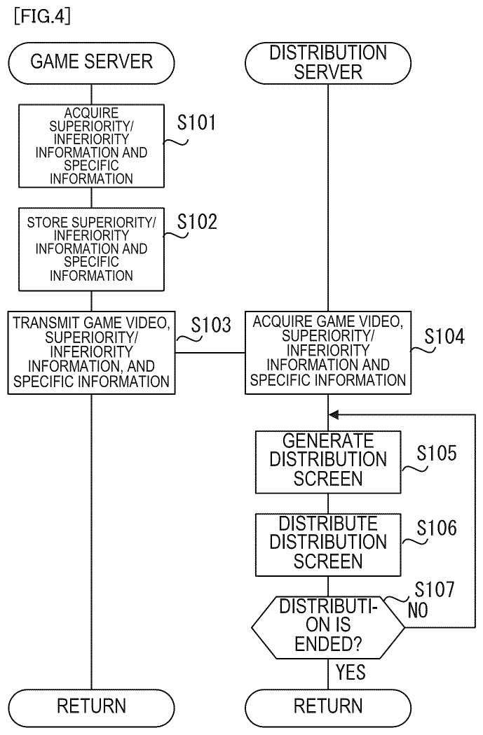

Next, processing in the generative system 100 will be described with reference to a flowchart in FIG. 4. First, the information generation unit 71A of the game terminal 70 analyzes a battle situation, creates superiority/inferiority information and specific information, and transmits the information to the game server 60. Then, the information acquisition unit 61B of the game server 60 acquires the superiority/inferiority information and the specific information (S101). Further, the information acquisition unit 61B stores the received superiority/inferiority information D2 in the server storage unit 62, and stores the received specific information in the server storage unit 62 as the object list D3 (S102).

Then, the server control unit 61 transmits the game video, the superiority/inferiority information D2, and the object list D3 as the specific information to the distribution server 30 (S103). Subsequently, the video acquisition unit 31B of the distribution server 30 acquires the game video transmitted by the server control unit 61 (S104). Further, the screen generation unit 31C of the distribution server 30 acquires the superiority/inferiority information D2 and the object list D3 transmitted by the server control unit 61 (S104).

Then, the screen generation unit 31C generates a distribution screen DS based on the game video, the superiority/inferiority information D2, and the object list D3 (S105). Thereafter, the distributing unit 31A of the distribution server 30 distributes the distribution screen DS generated by the screen generation unit 31C to each reproduction terminal 20 (S106). Then, the reproduction terminal 20 displays the distribution screen DS, and when the distribution is ended (YES in S107), the distribution server 30 ends the processing. On the other hand, when the distribution has not ended (NO in S107), the screen generation unit 31C generates the distribution screen DS (S105).

According to the generative system 100 according to the first embodiment described above, the viewer can easily recognize the reason for the superiority/inferiority indicated in the superiority/inferiority display area AR1. In addition, the viewer can recognize the factor object that has affected the superiority/inferiority indicated in the superiority/inferiority display area AR1. Therefore, a degree of understanding of the battle situation of the game is increased, and the viewer can enjoy the game video more.

### Second Embodiment

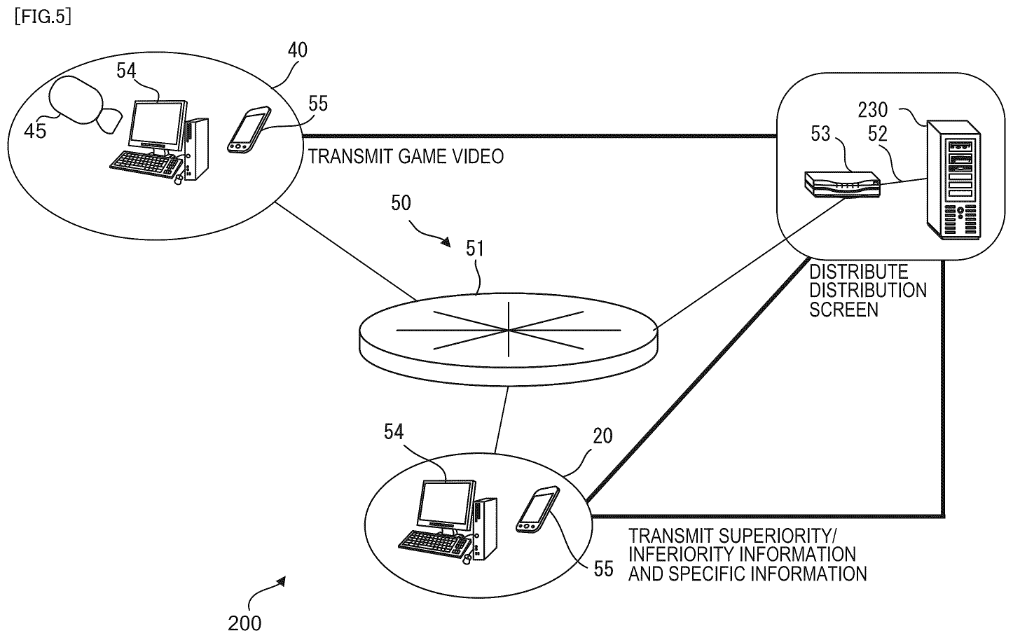

A second embodiment will be described with reference to FIGS. 5 to 8. The second embodiment is different from the first embodiment in that the distribution server 230 acquires the superiority/inferiority information and the specific information. Incidentally, in the description of the second embodiment, differences from the first embodiment will be described. The already described components are denoted by the same reference signs, and the description thereof will be omitted. Unless otherwise described, the components denoted by the same reference signs exhibit substantially the same operation and function, and the functions and effects thereof are also substantially the same.

As illustrated in FIG. 5, the generative system 200 that generates the distribution screen DS of the viewing video also functions as a distribution system, and includes a reproduction terminal 20, a distribution server 230, and a distribution terminal 40 by which the distributor uploads the video. The distribution terminal 40 can be coupled to the distribution server 230 via a predetermined network 50. As an example, the distributor uses the distribution terminal 40 at a site of a game tournament or the like. Incidentally, the distribution server 230 and the distribution terminal 40 may be coupled to each other via the Internet 51 instead of or in addition to the LAN 52.

The distribution server 230 is configured as one logical server device by combining server units as a plurality of computers. In addition, the distribution server 230 receives a user operation input by the viewer from the reproduction terminal 20. For example, the viewer can input the superiority/inferiority information and the specific information using the reproduction terminal 20. Further, the distribution server 230 manages terminal identification information (for example, a terminal ID) for identifying each reproduction terminal 20 and the input superiority/inferiority information and the specific information in association with viewer identification information (for example, a viewer ID) for uniquely identifying each viewer. As an example, in a comment input field displayed on the reproduction terminal 20, the viewer can post which player is superior or inferior as the superiority/inferiority information. Alternatively, the viewer can input which player is superior or inferior by performing a touch operation on a voting icon displayed on the reproduction terminal 20. Furthermore, the viewer can post a card name or the like as specific information indicating a factor object in the comment input field.

In addition, the distribution server 230 distributes the distribution screen DS including the game video received from the distribution terminal 40 by generating the distribution screen DS. Alternatively, the distribution server 230 may distribute the viewing video received from a device other than the distribution terminal 40. For example, the distribution server 230 may distribute the distribution screen DS including the game video received from a game machine or the game server 60 that provides a game service to the game machine. In this case, the distribution server 230 distributes the distribution screen DS including the game video uploaded from the game machine or the game server 60 to the reproduction terminal 20.

The distribution terminal 40 is a computer device capable of network coupling. For example, the distribution terminal 40 includes a stationary or book type personal computer 54 and a mobile terminal device 55 such as a mobile phone (including a smartphone). In addition, various computer devices such as a stationary home game device, a portable game device, and a portable tablet terminal device are included in the distribution terminal 40. The distribution terminal 40 can allow the user to enjoy various services provided by the distribution server 230 by implementing various computer software.

In addition, the distribution terminal 40 acquires a camera video as a game video from the photographing device 45 that photographs a player who fights using a physical object (for example, a game element such as a card). As an example, the photographing device 45 is a video camera, and is installed in a site of a game tournament or the like. Then, the distribution terminal 40 transmits the acquired camera video to the distribution server 30 as a game video or a game video in which the camera video is superimposed on a part of the game screen. Alternatively, the distribution server 30 may directly acquire the camera video as the game video from the photographing device 45.

### [Outline of Game]

In the following description, an example of a trading card game using a physical group of cards called a deck will be mainly described. The player fights against the opponent player using a plurality of cards selected from the deck created by the player as hands. In the battle, a turn of the player and a turn of the opponent player are alternately repeated. Then, in the turn of the player, the player attacks the opponent player with the card selected from the hands, and decreases a life point of the opponent player. As a result, when the life point of the opponent player disappears, the player wins against the opponent player.

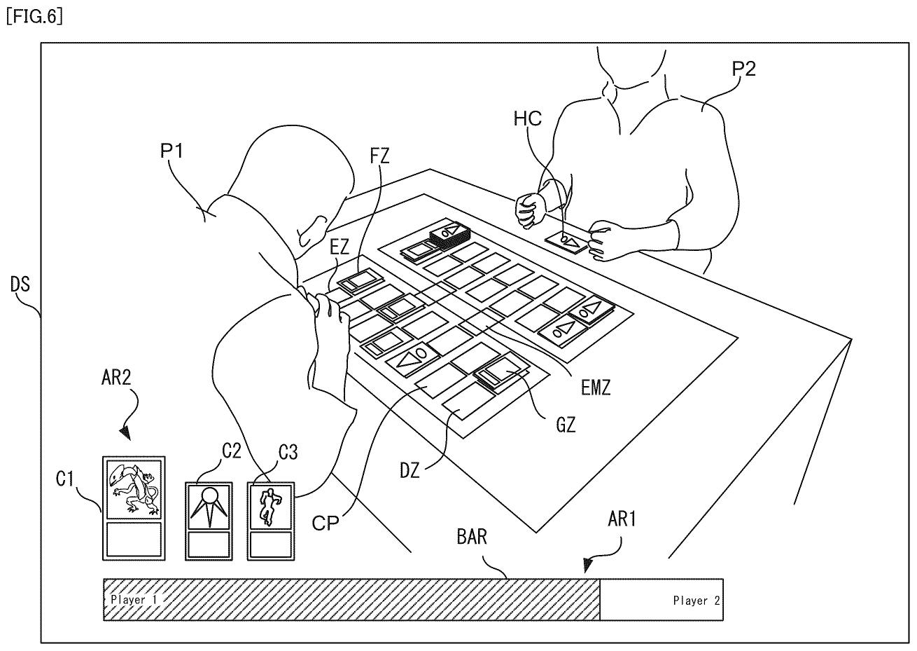

FIG. 6 illustrates an example of the distribution screen DS including the camera video as the game video. A game using physical cards is advanced using a game field as an example of a place where the cards are to be disposed by a player P1 and a player P2. A plurality of card placement places CP are set in the game field. As an example, ten card placement places CP are set for each player. In addition, in the game field, a cemetery zone GZ in which broken or used cards are placed and a field zone FZ in which field magic cards that affect the entire field are placed are set. In addition, in the game field, an extra deck zone EZ in which cards that can be summoned in a special method are placed and a deck zone DZ in which a deck is placed are set. Further, an extra monster zone EMZ is set so as to overlap a boundary between a game field of the player P1 and a game field of the player P2.

Each player forms a deck to be used in the game from a large number of cards owned by the player, and advances the game while appropriately disposing the cards included in the deck in the card placement place CP or each zone. In the game, each player holds some cards as hands HC or places some cards at an appropriate position outside the game field. For example, in FIG. 6, the player P2 places the hand HC outside the game field.

The game progresses in a so-called turn-based system in which turns are alternately repeated between players. First, each player shuffles the deck, disposes the deck in the deck zone DZ, and draws a predetermined number of cards from the deck of the player and holds the cards as the hands HC. When the preparation is completed, the game is started from a turn of a player who attacks first. One turn is divided into a plurality of phases.

Each player selects an appropriate action within a range determined for each phase. As an example, in a phase 1, a card is drawn from the deck, and in a phase 2, an effect of the card to be subjected to effect processing in the phase can be activated. In a phase 3, various actions such as calling (or summon) of a virtual character or the like such as a monster used in a battle, setting of a card having a unique effect such as a magic or a trap, or activation of an effect of a card are permitted while appropriately using the card. In a phase 4, a battle using the card is performed. Instead of or in addition to the card, the opponent player may be the attack target.

The result of the battle is determined according to parameters such as the attribute and strength of the card. In a phase 5, the end of the turn is declared. Incidentally, each player can avoid the battle of the phase 4 by his/her own selection. In the case, the phase 4 is skipped. The progress of the phase (for example, the end of the turn) is performed by an utterance or a gesture by each player. Then, when a predetermined end condition is satisfied while the turns are alternately repeated, the game ends. The end condition is satisfied, for example, when a value of a parameter such as a life point set to each player decreases to a predetermined value due to the battle.

### [Control System of Generative System 200]

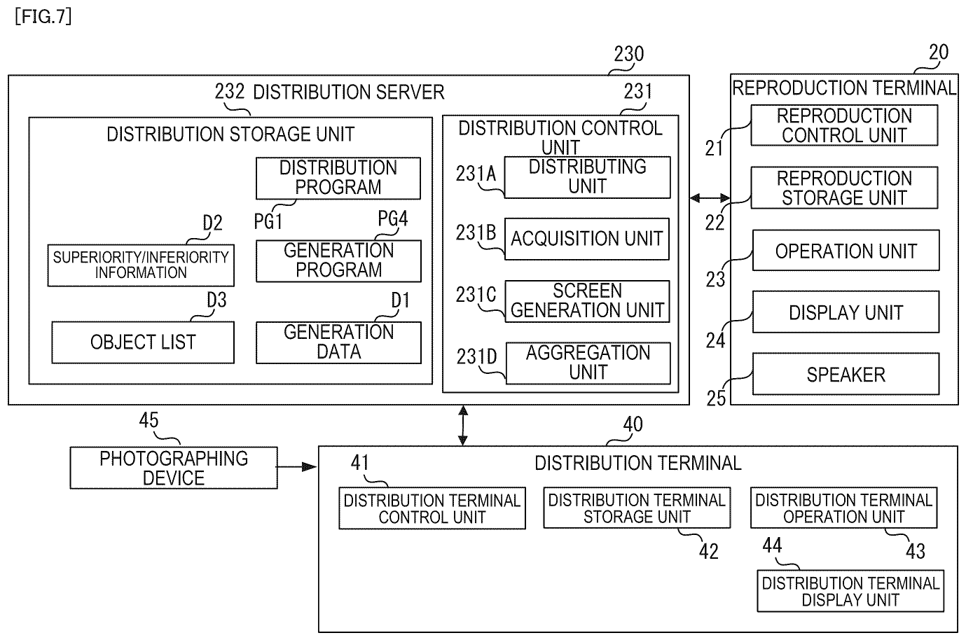

Next, a control system of a generative system 200 will be described with reference to FIG. 7. The distribution server 230 includes a distribution control unit 231, a distribution storage unit 232, and a communication unit (not illustrated). The distribution control unit 231 executes various controls for distributing the distribution screen DS including the game video uploaded from the distribution terminal 40. In addition, the distribution storage unit 232 stores a distribution program PG1 which is a control program of the distribution server 230. In addition, the distribution storage unit 232 stores a generation program PG4 functioning as a control program of the generative system 200 and generation data D1 used to generate the distribution screen. The generation data D1 includes image data of images displayed in the superiority/inferiority display area AR1 and the object display area AR2, data of a screen configuration, and the like.

The distribution control unit 231 is configured as a computer in which a processor that executes various types of arithmetic processing and operation control according to a predetermined program, an internal memory necessary for the operation of the processor, and other peripheral devices are combined. Then, the distribution control unit 231 includes a distributing unit 231A as an example of a distributing device, an acquisition unit 231B as an example of an information acquisition device and a video acquisition device, a screen generation unit 231C as an example of a screen generation device, and an aggregation unit 231D as an example of an aggregation device. The distributing unit 231A, the acquisition unit 231B, the screen generation unit 231C, and the aggregation unit 231D are logical devices realized by a combination of hardware resources and software resources of the distribution control unit 231. In addition, the distribution storage unit 232 is a storage device including a computer-readable non-transitory storage medium.

The distributing unit 231A distributes a distribution screen DS generated by the screen generation unit 231C to each reproduction terminal 20. Therefore, as illustrated in FIG. 6, the screen generation unit 231C generates the distribution screen DS such that the superiority/inferiority display area AR1 and the object display area AR2 are located on the same screen. That is, the screen generation unit 231C generates the distribution screen DS so as to include the game video (and the display region of the game video), the superiority/inferiority display area AR1, and the object display area AR2. Incidentally, the screen generation unit 231C acquires the superiority/inferiority information D2 stored in the distribution storage unit 232 by the acquisition unit 231B. In addition, the screen generation unit 31C acquires the object list D3 stored in the distribution storage unit 232 by the acquisition unit 231B as specific information. Further, the screen generation unit 231C receives the game video from the acquisition unit 231B.

The acquisition unit 231B as an information acquisition device acquires superiority/inferiority information and specific information. For example, the acquisition unit 231B acquires, from the plurality of reproduction terminals 20 to which the distribution screen DS is distributed, superiority information indicating a superior one among the opponents or inferior information indicating an inferior one among the opponents. Then, the aggregation unit 231D passes a superiority/inferiority aggregation result obtained by aggregating the superiority information or the inferiority information to the acquisition unit 231B. As a result, the acquisition unit 231B acquires the superiority/inferiority aggregation result as the superiority/inferiority information D2, and stores the result in the distribution storage unit 232 in association with player identification information for uniquely identifying each player and information indicating a time zone.

For example, the aggregation unit 231D aggregates the number of posts of a player name or a player ID of a player who is superior as the superiority information. Alternatively, the aggregation unit 231D aggregates the number of posts of a player name or a player ID of a player who is inferior as the inferiority information. As an example, it is assumed that the number of posts indicating that the player P1 is superior at a certain turn is 3000 and the number of posts indicating that the player P2 is superior is 1000. In this case, the possibility of the player P1 winning is three times the player P2, and the length of the superiority/inferiority display bar BAR of the player P1 is three times the player P2.

In addition, the acquisition unit 231B acquires information (for example, a card name or a card ID) indicating the factor object from the plurality of reproduction terminals 20. Then, the aggregation unit 231D passes an object aggregation result obtained by aggregating the information to the acquisition unit 231B. As a result, the acquisition unit 231B acquires the object aggregation result as the specific information. Then, the acquisition unit 231B stores the object list D3 based on the object aggregation result in the distribution storage unit 232 in association with the information indicating the time zone. For example, the acquisition unit 231B stores a list for specifying a predetermined number (for example, three) of factor objects in each time zone (for example, each turn or each phase) as the object list D3. Incidentally, the aggregation unit 231D may aggregate only the information indicating the object used by the player among the information indicating the factor object acquired from each reproduction terminal 20. Then, the acquisition unit 231B stores the object list D3 based on the object aggregation result thus aggregated in the distribution storage unit 232 in association with the information indicating each player. As a result, even when the viewer erroneously selects an object that is not used by the player, the objects can be aggregated correctly.

As a result, the generative system 200 can create the superiority/inferiority information and the specific information without preparing a process of analyzing the battle situation or without preparing a person who analyzes the battle situation. Furthermore, since the view of the viewer can be reflected in the superiority/inferiority information and the specific information, a degree of satisfaction of the viewer can be further increased.

Alternatively, the acquisition unit 231B may acquire the superiority/inferiority information D2 stored in advance by the operator and the object list D3 as the specific information from the distribution storage unit 232. As a result, it is possible to indicate the superiority/inferiority in the superiority/inferiority display area AR1 and indicate the factor object in the object display area AR2 using the information stored in advance. As an example, the operator of the distribution server 230 stores the superiority/inferiority information D2 and the object list D3 in real time or in advance in the distribution storage unit 232. In addition, the acquisition unit 231B may acquire the superiority/inferiority information and the specific information from the game terminal 70 or the distribution terminal 40. In this case, the distribution server 230 includes the distribution storage unit 232 as an example of a storage device that stores the superiority/inferiority information and the specific information. Then, the acquisition unit 231B acquires the superiority/inferiority information D2 and the object list D3 from the distribution storage unit 232. Incidentally, the superiority/inferiority information D2 and the object list D3 in this case may be information based on information collected from the viewer in advance.

In addition, the reproduction application software of the reproduction terminal 20 or the distributing unit 231A of the distribution server 230 may request the viewer to input the superiority/inferiority information and the specific information at a predetermined timing. As an example, the timing for requesting the input is the end or start of each turn or the end or start of each phase. The reproduction terminal 20 transmits the superiority/inferiority information and the specific information to the distribution server 230 in response to the input. Alternatively, the reproduction terminal 20 transmits the superiority/inferiority information and the specific information to the distribution server 230 in response to the transmission request from the distribution server 230.

Incidentally, the aggregation unit 231D performs aggregation at a predetermined timing (for example, at the end of each turn or each phase), and creates a superiority/inferiority aggregation result and an object aggregation result. In addition, the aggregation unit 231D may create a ratio of the number of posts to each player with respect to the total number of posts as the superiority/inferiority aggregation result instead of an absolute number (for example, the number of posts).

In addition, the aggregation unit 231D may determine the content of the comment input by the viewer at the time of aggregation, and specify the player or the factor object corresponding to the content of the comment. For example, the aggregation unit 231D analyzes a sentence included in the comment, and when a player name is included in the comment, determines whether it matches a player name of the player currently fighting. Then, when both coincide with each other, the number of posts with respect to the player specified by the player name is added. Similarly, when an object name is included in the comment, the number of posts with respect to the object specified by the object name is added.

The acquisition unit 231B as a video acquisition device acquires a game video of a game. As an example, the acquisition unit 231B acquires the game video from the distribution terminal 40. Alternatively, the acquisition unit 231B may acquire a camera video as a game video from the photographing device 45. Further, the acquisition unit 231B may acquire the game video from the game terminal 70. Then, the screen generation unit 231C generates the distribution screen DS such that the game video acquired by the acquisition unit 231B, the superiority/inferiority display area AR1, and the object display area AR2 are located on the same screen. Alternatively, the acquisition unit 231B may regenerate the game video by rendering key information received from the game terminal 70 or the game server 60.

### [Distribution Terminal 40]

The distribution terminal 40 includes a distribution terminal control unit 41, a distribution terminal storage unit 42, a distribution terminal operation unit 43, a distribution terminal display unit 44, and a communication unit (not illustrated). The distribution terminal storage unit 42 stores a control program of the distribution terminal 40. The distribution terminal control unit 41 controls the distribution terminal 40 and executes upload of a video such as a game video. In addition, the distribution terminal operation unit 43 is an operation device such as a mouse, a keyboard, a controller, or a touch panel, and receives input of an operation such as upload by the distributor or input of a comment while distributing. The distribution terminal display unit 44 is a display device such as a television, a display, or a touch panel, and displays a game video or the like distributed by the distributor. The distribution terminal operation unit 43 and the distribution terminal display unit 44 may be integrally configured as a display operation unit such as a touch panel.

Further, the distribution terminal 40 includes a voice output device such as a speaker (not illustrated) and a voice input device such as a microphone. In addition, the distribution terminal 40 may include a photographing device 45 such as a camera that photographs a player or the like. In this case, the distribution terminal 40 uploads the camera video photographed by the camera to the distribution server 230 as needed. Incidentally, when a game is played in the distribution terminal 40, the distribution terminal control unit 41 controls the progress of the game by executing a game program stored in the distribution terminal storage unit 42.

The distribution terminal control unit 41 is configured as a computer in which a processor that executes various types of arithmetic processing and operation control according to a predetermined program, an internal memory necessary for the operation of the processor, and other peripheral devices are combined. As an example, these processors are CPUs or MPUs, and control the entire device based on a predetermined program, and also control various types of processing in an integrated manner. Incidentally, the distribution terminal control unit 41 can also perform control according to a program stored in a portable recording medium such as a CD, a DVD, a CF card, and a USB memory, or an external storage medium such as a server on the Internet.

The distribution terminal storage unit 42 is a storage device including a computer-readable non-transitory storage medium. Further, the distribution terminal storage unit 42 includes a RAM which is a system work memory for the processor to operate, and a storage device such as a ROM, an HDD, and an SSD in which a program and system software are stored. The processor can execute various processing operations such as calculation, control, and determination according to a control program stored in the ROM or the HDD. Incidentally, the distribution terminal storage unit 42 may hold all the data in one storage device, or may store the data in a plurality of storage devices in a distributed manner.

### [Processing by Generative System 200]

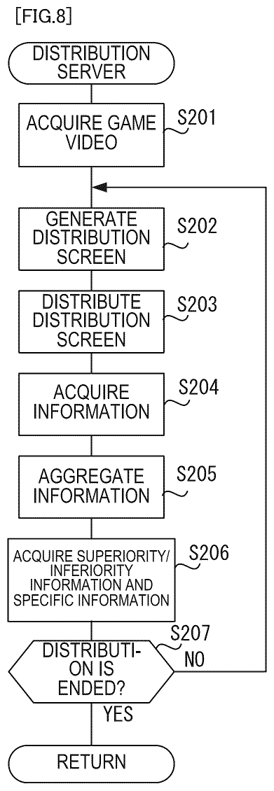

Next, processing in the generative system 200 will be described with reference to a flowchart in FIG. 8. First, the acquisition unit 231B as a video acquisition device acquires a game video of a game (S201). For example, the acquisition unit 231B acquires a game video for livestreaming from the distribution terminal 40. Then, the screen generation unit 231C generates a distribution screen DS including the game video (S202). At this time, before superiority/inferiority information and specific information are acquired, the superiority/inferiority display area AR1 and the object display area AR2 are in an initial state. For example, in the superiority/inferiority display area AR1 in the initial state, the superiority/inferiority display bars BAR having the same length with respect to both the opponents is displayed such that there is no difference in superiority/inferiority. In addition, in the object display area AR2 in the initial state, an image, a card name, or the like for specifying a factor object is not displayed.

Then, the distributing unit 231A distributes the distribution screen DS generated by the screen generation unit 231C to each reproduction terminal 20 (S203). Thereafter, at a predetermined timing, the acquisition unit 231B as an information acquisition device acquires superiority information or inferiority information from the plurality of reproduction terminals 20 (S204). In addition, the acquisition unit 231B acquires information indicating a factor object from the plurality of reproduction terminals 20 (S204). Then, the aggregation unit 231D aggregates the superiority information or the inferiority information (S205), and passes a superiority/inferiority aggregation result to the acquisition unit 231B. In addition, the aggregation unit 231D aggregates the information indicating the factor object (S205), and passes an object aggregation result to the acquisition unit 231B.

As a result, the acquisition unit 231B acquires the superiority/inferiority aggregation result as superiority/inferiority information D2, and acquires the object aggregation result as specific information (S208). Then, the acquisition unit 231B stores the superiority/inferiority information D2 in the distribution storage unit 232, and stores the specific information in the distribution storage unit 232 as an object list D3. When the distribution has not ended (NO in S207), the screen generation unit 231C generates the distribution screen DS based on the game video and the stored superiority/inferiority information D2 and the object list D3 (S202). Then, the distributing unit 231A distributes the distribution screen DS generated by the screen generation unit 231C to each reproduction terminal 20 (S203). On the other hand, when the distribution ends (YES in S207), the distribution server 230 ends the processing.

Also by the generative system 200 according to the second embodiment described above, the viewer can easily recognize the reason for the superiority/inferiority indicated in the superiority/inferiority display area AR1. In addition, the viewer can recognize the factor object that has affected the superiority/inferiority indicated in the superiority/inferiority display area AR1. Therefore, a degree of understanding of the battle situation of the game is increased, and the viewer can enjoy the game video more.

Hitherto, the present invention has been described with reference to each embodiment, but the present invention is not limited to the above embodiments. Inventions modified within a range without contradictory to the present invention and inventions equivalent to the present invention are also included in the present invention. In addition, each embodiment, each modification, and technical means included in each embodiment or each modification can be appropriately combined within a range without contradictory to the present invention.

For example, in the first embodiment, the information acquisition unit 61B provided in the game server 60 or functional units corresponding to some functions of the information acquisition unit 61B may be provided in the distribution server 30. In addition, the screen generation unit 31C provided in the distribution server 30 may be provided in the game server 60. In addition, in the second embodiment, the generative system 200 may further include the game server 60. In this case, at least one of the acquisition unit 231B, the screen generation unit 231C, and the aggregation unit 231D, or functional units corresponding to some functions of at least one functional unit thereof may be provided in the game server 60.

Hereinafter, various aspects derived from the above-described embodiments and modifications will be described. Incidentally, in order to facilitate understanding of each aspect, reference numerals illustrated in the accompanying drawings are added. However, the reference numerals are not intended to limit the present invention to the illustrated form.

A generative system 100, 200 is the generative system 100, 200 that generates a distribution screen DS of a viewing video of a battle type game in which win or lose is determined by changing a battle situation according to use of a game object by each opponent and includes a computer 61, 31, 231, wherein the computer 61, 31, 231: acquires superiority/inferiority information indicating superiority or inferiority of the battle situation and specific information specifying a factor object that is a factor of the battle situation among the game objects; and generates the distribution screen DS such that a superiority/inferiority display area AR1 indicating the superiority or inferiority of the battle situation for at least one opponent based on the superiority/inferiority information and an object display area AR2 indicating the factor object based on the specific information are located on a same screen.

A control program PG2, PG3 is the control program PG2, PG3 of a generative system 100, 200 that generates a distribution screen DS of a viewing video of a battle type game in which win or lose is determined by changing a battle situation according to use of a game object by each opponent and includes a computer 61, 31, 231, the control program PG2, PG3 causing the computer 61, 31, 231 to: acquire superiority/inferiority information indicating superiority or inferiority of the battle situation and specific information specifying a factor object that is a factor of the battle situation among the game objects; and generate the distribution screen DS such that a superiority/inferiority display area AR1 indicating the superiority or inferiority of the battle situation for at least one opponent based on the superiority/inferiority information and an object display area AR2 indicating the factor object based on the specific information are located on a same screen.

A control method is the control method of a generative system 100, 200 that generates a distribution screen DS of a viewing video of a battle type game in which win or lose is determined by changing a battle situation according to use of a game object by each opponent and includes a computer 61, 31, 231, the control method comprising: acquiring by the computer 61, 31, 231, superiority/inferiority information indicating superiority or inferiority of the battle situation and specific information specifying a factor object that is a factor of the battle situation among the game objects; and generating by the computer, the distribution screen DS such that a superiority/inferiority display area AR1 indicating the superiority or inferiority of the battle situation for at least one opponent based on the superiority/inferiority information and an object display area AR2 indicating the factor object based on the specific information are located on a same screen.

The generative system 100, 200 further comprises: a game device 70 for playing the game, wherein the game device 70 analyzes the battle situation to create the superiority/inferiority information and the specific information, and the computer 61, 31, 231 acquires the superiority/inferiority information and the specific information from the game device 70.

The computer 61, 31, 231 acquires a game video of the game and generates the distribution screen DS such that the game video, the superiority/inferiority display area AR1, and the object display area AR2 are located on the same screen.

The generative system 100, 200 further comprises: a storage device 62, 232 that stores the superiority/inferiority information and the specific information, wherein the computer 61, 31, 231 acquires the superiority/inferiority information and the specific information from the storage device 62, 232.

The computer 61, 31, 231: acquires, from a plurality of reproduction terminals 20 to which the distribution screen DS is to be distributed, superiority information indicating a superior opponent among the opponents or inferiority information indicating an inferior opponent among the opponents, and acquires a superiority/inferiority aggregation result obtained by aggregating the superiority information or the inferiority information as the superiority/inferiority information; and acquires information indicating the factor object from the plurality of reproduction terminals 20, and acquires an object aggregation result obtained by aggregating the information as the specific information.

The computer 61, 31, 231 generates the distribution screen DS such that an explanation area of the factor object is located on the same screen together with the object display area AR2. The computer 61, 31, 231 changes display contents in the superiority/inferiority display area AR1 and the object display area ARC according to a change in the battle situation, and generates the distribution screen DS so as to include a history display area in which a past display content displayed before a latest display content is to be displayed.

What is claimed is:

1. A generative system that generates a distribution screen of a viewing video of a battle type game in which win or lose is determined by changing a battle situation according to use of a game object by each opponent and includes a computer, wherein the computer:
acquires superiority/inferiority information indicating superiority or inferiority of the battle situation and specific information specifying a factor object that is a factor of the battle situation among the game objects; and
generates the distribution screen such that a superiority/inferiority display area indicating the superiority or inferiority of the battle situation for at least one opponent based on the superiority/inferiority information and an object display area indicating the factor object based on the specific information are located on a same screen.

2. The generative system according to claim 1, further comprising:
a game device for playing the game,
wherein the game device analyzes the battle situation to create the superiority/inferiority information and the specific information, and
the computer acquires the superiority/inferiority information and the specific information from the game device.

3. The generative system according to claim 1, wherein the computer acquires a game video of the game and generates the distribution screen such that the game video, the superiority/inferiority display area, and the object display area are located on the same screen.

4. The generative system according to claim 1, further comprises:
a storage device that stores the superiority/inferiority information and the specific information,
wherein the computer acquires the superiority/inferiority information and the specific information from the storage device.

5. The generative system according to claim 1, wherein the computer:
acquires, from a plurality of reproduction terminals to which the distribution screen is to be distributed, superiority information indicating a superior opponent among the opponents or inferiority information indicating an inferior opponent among the opponents, and acquires a superiority/inferiority aggregation result obtained by aggregating the superiority information or the inferiority information as the superiority/inferiority information; and
acquires information indicating the factor object from the plurality of reproduction terminals, and acquires an object aggregation result obtained by aggregating the information as the specific information.

6. The generative system according to claim 1, wherein the computer generates the distribution screen such that an explanation area of the factor object is located on the same screen together with the object display area.

7. The generative system according to claim 1, wherein the computer changes display contents in the superiority/inferiority display area and the object display area according to a change in the battle situation, and generates the distribution screen so as to include a history display area in which a past display content displayed before a latest display content is to be displayed.

8. A computer-readable non-transitory storage medium storing a control program of a generative system that generates a distribution screen of a viewing video of a battle type game in which win or lose is determined by changing a battle situation according to use of a game object by each opponent and includes a computer, the control program causing the computer to:
acquire superiority/inferiority information indicating superiority or inferiority of the battle situation and specific information specifying a factor object that is a factor of the battle situation among the game objects; and
generate the distribution screen such that a superiority/inferiority display area indicating the superiority or inferiority of the battle situation for at least one opponent based on the superiority/inferiority information and an object display area indicating the factor object based on the specific information are located on a same screen.

9. A control method of a generative system that generates a distribution screen of a viewing video of a battle type game in which win or lose is determined by changing a battle situation according to use of a game object by each opponent and includes a computer, the control method comprising:
acquiring by the computer, superiority/inferiority information indicating superiority or inferiority of the battle situation and specific information specifying a factor object that is a factor of the battle situation among the game objects; and
generating by the computer, the distribution screen such that a superiority/inferiority display area indicating the superiority or inferiority of the battle situation for at least one opponent based on the superiority/inferiority information and an object display area indicating the factor object based on the specific information are located on a same screen.
